(19) United States
(12) Patent Application Publication
(10) Pub. No.: US 2024/0217795 A1
(43) Pub. Date: Jul. 4, 2024

(54) Forklift Assembly

(71) Applicant: New Heights, LLC, Leola, PA (US)

(72) Inventors: William Fisher, Paradise, PA (US); Josiah Harthcock, Lancaster, PA (US); Jeremiah Weaver, Narvon, PA (US); Raymond Beiler, New Holland, PA (US); Aaron Jay Beiler, Gap, PA (US)

(73) Assignee: New Heights, LLC, Leola, PA (US)

(21) Appl. No.: 18/147,393

(22) Filed: Dec. 28, 2022

(51) Int. Cl. B66F 9/065; B66F 9/075; B66F 9/12

(52) U.S. Cl. CPC B66F 9/0655; B66F 9/07586; B66F 9/125

(57) ABSTRACT

A forklift assembly is provided and generally includes a frame, a movement system assembly having, an extension assembly coupled to the rear support assembly, and a carriage assembly. The frame includes a front support assembly and a rear support assembly. The movement system assembly includes having a plurality of sensors. The extension assembly is coupled to the rear support assembly and includes a boom support, a sliding support positioned within the boom support, a sliding mechanism positioned within the sliding support, and a raising mechanism coupled to an outer edge of the boom support. The carriage assembly includes a knuckle rotation assembly, a carriage movement assembly, a back rest assembly coupled to the knuckle rotation assembly and the carriage movement assembly; a prong assembly, and a locking assembly.

### FIELD OF THE INVENTION

The present invention relates to a forklift assembly, and more particularly to a self-propelled forklift assembly.

### BACKGROUND

In general, forklifts are often slow, heavy and difficult to control. Moreover, forklifts require an operator to be positioned on the forklift at all times in order to control the forklift's movement. However, an operator on a forklift is a dangerous profession. The operator can lose control when on the forklift and either hurt themselves or the coworkers around them.

Additionally, because forklifts are often large and heavy machinery, it requires time consuming efforts to transport a machine of this caliber. Moreover, once the machinery is loaded, it is often bulky and requires a lot of effort to secure it.

Further, forklifts tend to require a flat and planar surface in order to function properly because it lacks the ability to adjust to the terrain. Since the traditional forklift cannot adjust to the terrain, it is therefore obsolete and unable to perform tasks outside a level terrain.

It is desirable to design an unmanned and remote control forklift, that is easily transportable and has the ability to adjust its center of gravity to compensate for the uneven terrain. Therefore, there is a need for a self-propelled forklift assembly.

As the foregoing illustrates, the invention provides the self-propelled forklift assembly.

### SUMMARY

A forklift assembly comprising a frame having a front support assembly. The front support assembly having a pair of connecting beams and a front support actuator positioned to a central region of the front support assembly. The front support assembly further having a front wheel assembly. The frame further having a rear support assembly. The rear support assembly is coupled to the front support assembly. The rear support assembly having a rear frame support, an extending support, a frame actuator assembly positioned within the extending support, and a rear wheel assembly. The forklift assembly further comprising a movement system assembly having a control system. The control system having a plurality of sensors. The forklift assembly further comprising an extension assembly coupled to the rear support assembly. The extension assembly having a boom support, a sliding support positioned within the boom support, a sliding mechanism positioned within the sliding support, and a raising mechanism coupled to an outer edge of the boom support. The forklift assembly further comprising a carriage assembly having a knuckle rotation assembly, a carriage movement assembly positioned within the knuckle rotation assembly, a back rest assembly coupled to the knuckle rotation assembly and the carriage movement assembly. The carriage assembly further having a prong assembly. The plurality of sensors identify a level of the frame and a slope of the extension assembly. The front support actuator assembly and frame actuator assembly compensate for a ground surface through the plurality of sensors.

### BRIEF DESCRIPTION OF DRAWINGS

In the following, the present invention is described in more detail with references to the drawings in which:

FIG. 1 illustrates a forklift assembly of the present invention;

FIG. 2 illustrates a rear view of the invention of FIG. 1;

FIG. 3 illustrates a front view of the invention of FIG. 2;

FIG. 4 illustrates a top, front, left side view of the invention of FIG. 3;

FIG. 5 illustrates a cross-sectional view of the invention of FIG. 4;

FIG. 6 illustrates another cross-sectional view of the invention of FIG. 5;

FIG. 7 illustrates a top, front, left side view of the invention of FIG. 6;

FIG. 8 illustrates another cross-sectional view of the invention of FIG. 7;

FIG. 9 illustrates an exploded view of the invention of FIG. 8;

FIG. 10 illustrates a cross-sectional view of the invention of FIG. 9;

FIG. 11 illustrates a top view of the invention of FIG. 10;

FIG. 12 illustrates a left side view of the invention of FIG. 11;

FIG. 13 illustrates a top view of the invention of FIG. 12;

FIG. 14 illustrates another embodiment of a top view of the invention of FIG. 13;

FIG. 15 illustrates another cross-sectional view of the invention of FIG. 14;

FIG. 16 illustrates another embodiment of the cross-sectional view of the invention of FIG. 15;

FIG. 17 is another cross-sectional view of the invention of FIG. 16;

FIG. 18 is another embodiment of the cross-sectional view of the invention of FIG. 17;

FIG. 19 is a front, left side view of the invention of FIG. 18;

FIG. 20 is another cross-sectional view of the invention of FIG. 19

FIG. 21 is another cross-section view of the invention of FIG. 20;

FIG. 22 is another embodiment of the cross-sectional view of FIG. 21;

FIG. 23 is a top, rear, left view of the invention of FIG. 22;

FIG. 24 is a top, front, left view of the invention of FIG. 23;

FIG. 25 is a cross-sectional view of the invention of FIG. 24;

FIG. 26 is another cross-sectional view of the invention of FIG. 25;

FIG. 27 is front, top, left view of the invention of FIG. 26;

FIG. 28 is a left side view of the invention of FIG. 27;

FIG. 29 is a top, rear, left view of the invention of FIG. 28;

FIG. 30 is a left side view of the invention of FIG. 29; and

FIG. 31 is another left side view of the invention of FIG. 30.

### DETAILED DESCRIPTION OF THE EMBODIMENTS

With reference to the Figures, a forklift assembly 1 according to the invention is provided. In the exemplary embodiment, the forklift assembly 1 generally includes a frame 2, a drive assembly 4, an extension assembly 6, and a carrier assembly 8.

In the exemplary embodiment, the frame 2 generally has a front support assembly 10, and a rear support assembly 60.

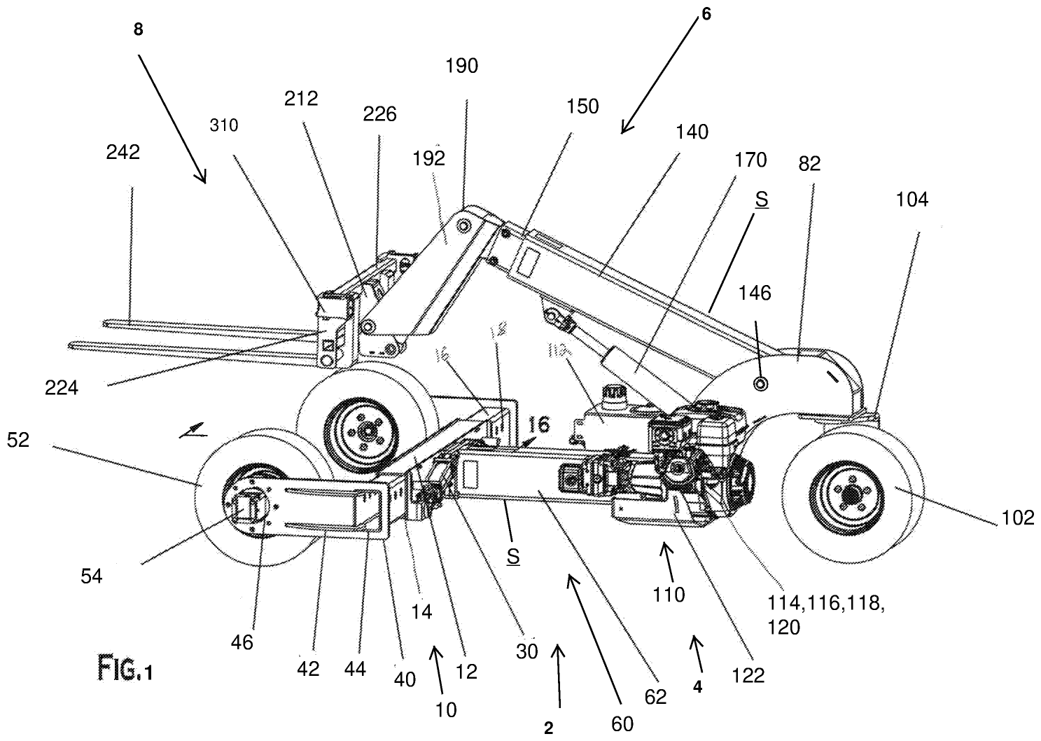

The front support assembly 10 has a front support beam 12. The front support beam 12 is an elongated metal support. The front support beam 12 extends horizontally with respect to the frame 2. The front support beam 12 is I-shaped. The front support beam 12 further includes a receiving space 14 as illustrated in FIG. 1.

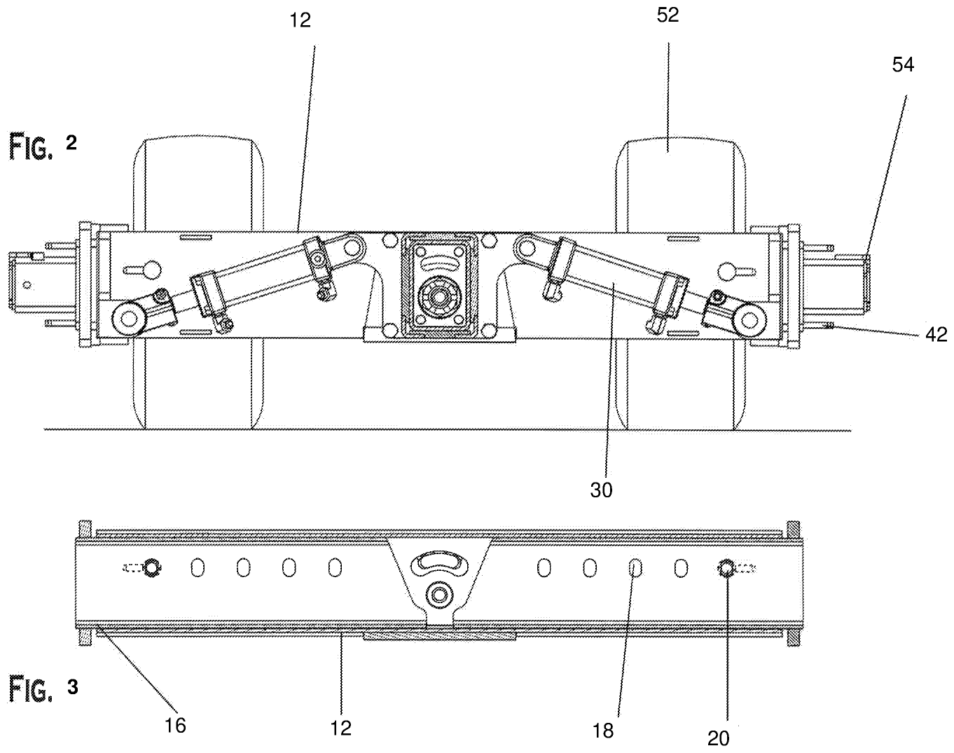

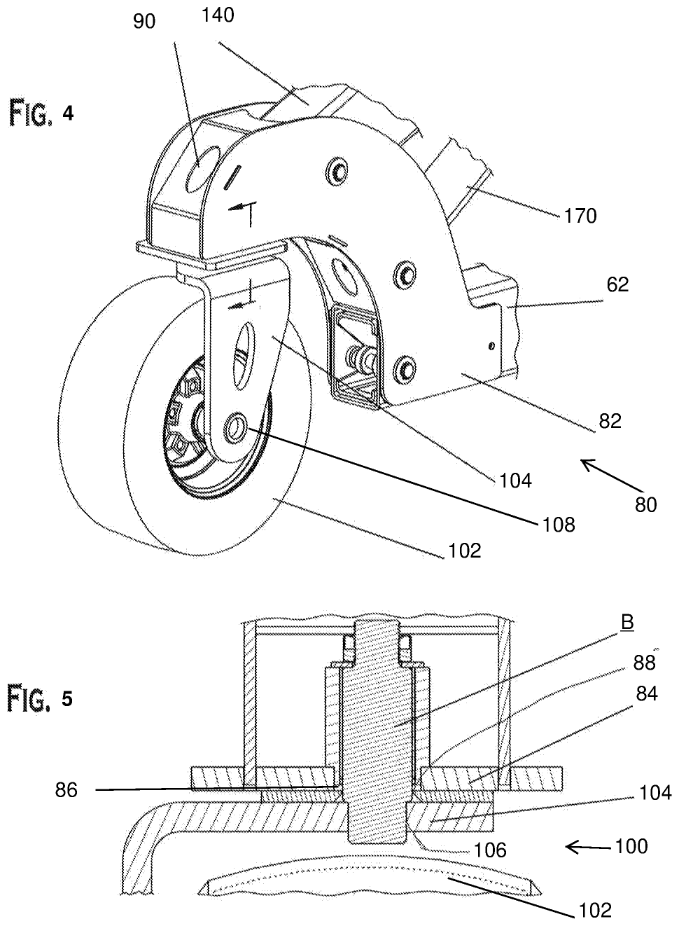

As illustrated, the front support assembly 10 further includes a pair of connecting beams 16. Each connecting beam 16 is a plate like member with a perimeter less than a perimeter of the front support beam 12. Each connecting beam 16, further includes a plurality of extension receivers 18 as shown FIG. 3. Each connecting beam 16 further includes a plurality of locking pins 20 for manual movement of the connecting beams.

As illustrated, the front support assembly 10 further includes a front support actuator assembly 30. The front support actuator assembly 30 is a pair of actuators. Each actuator includes an actuator which may be a known hydraulic cylinder having a barrel, a piston, piston rod, seals, and seal glands. However, one skilled in the art should appreciate that other actuator systems operated by a source of energy, such as electric current, hydraulic fluid pressure, or pneumatic pressure.

As illustrated in FIG. 1, the front support assembly 10 further includes a front wheel assembly 40. The front wheel assembly 40 is a plate like member. The front wheel assembly 40 further includes a pair of clasps 42 as shown in FIG. 1. Each clasp 42 is a fin like member. The front wheel assembly 40 further includes a support beam receiver 44. The support beam receiver 44 is a rectangular passageway. The front wheel assembly 40 further includes a pair of front wheel connectors 46. Each front wheel connector 46 is an axel receiver.

The front support assembly 10 further includes a front wheel kit 50. The front wheel kit 50 is a pair of front wheels 52 and a front wheel axel connector 54. One skilled in the art would understand the applicant's design is not the exclusive embodiment.

In the exemplary embodiment, the rear support assembly 60 has a rear frame support 62. The rear frame support 62 is an elongated metal support beam. The rear frame support 62 extends perpendicular to the front support beam 12. The rear frame support 62 includes an inner frame passageway 64.

The rear support assembly 60 further includes an extending support 66 as illustrated in FIG. 6. The extending support 66 is an elongated structural beam having a frame actuator receiving passageway 68. The frame actuator receiving passageway 68 is an opening extending the length of the extending support 66. The frame actuator receiving passageway 68 is shaped to receive an actuator and as shown, a cross section area of the inner frame passageway 64 is larger than a cross section area of the extending support 66. As a result, a leading end of the extending support 66 is positioned through the inner frame passageway 64.

The rear support assembly 60 further includes a frame actuator assembly 70. The frame actuator assembly 70 is a hydraulic actuator. The hydraulic actuator includes an actuator which may be a known hydraulic cylinder having a barrel, a piston, piston rod, seals, and seal glands. However, one skilled in the art should appreciate that other actuator systems operated by a source of energy, such as electric current, hydraulic fluid pressure, or pneumatic pressure.

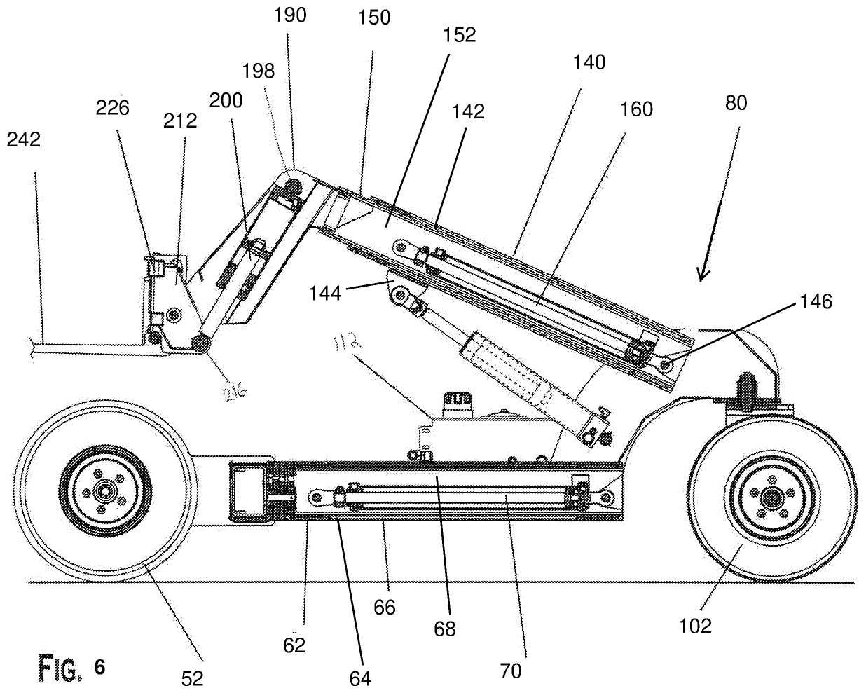

As illustrated, the rear support assembly 60 further includes a rear wheel assembly 80. The rear wheel assembly 80 includes a pair of arched like members 82. The rear support assembly 60 further includes a bottom plate 84 as shown in FIG. 5. The bottom plate 84 includes a bottom connector 86 as illustrated in FIG. 5. The rear wheel assembly 80 further includes a rear wheel connector 88. The rear wheel assembly 80 further includes a trailer connection slot 90.

The rear support assembly 60 further includes a rear wheel kit 100. The rear wheel kit 100 includes a rear wheel 102 and a fastening plate 104. The rear wheel 102 is a free floating wheel. The fastening plate 104 is an L-shaped member. The fastening plate 104 further includes a rear wheel receiver port 106 as illustrated in FIG. 5. The fastening plate 104 further includes an assembly connector 108 positioned at an opposite end from the rear wheel receiver port 106 as shown.

In the exemplary embodiment, the drive assembly 4 generally has a movement system assembly 110. The movement system assembly 110 generally has a control system 112 and a motor assembly 114 as shown in FIG. 1.

The control system 112 includes a plurality of controls which may be a series of wires and electronics for suitable controls to allow the operator to control the forklift assembly 1. The control system 112 therefore provides the operator with the ability to control all features of the forklift assembly 1 from a different location by remote control. The control system 112 further includes a plurality of sensors S distributed through the forklift assembly 1. Essentially distributed on the frame 2 and the extension assembly 6. The control system 112 allows the forklift assembly 1 to travel under its own power.

The motor assembly 114 generally includes a motor 116, a motor drive mechanism 118 and a motor housing 120 as illustrated. The motor 116 is connected to control system 112. The motor 116 is further connected to the plurality of actuators using hydraulic lines (not shown). The motor assembly 114 further includes a motor support 122. The motor support 122 is a plate like member. The motor 116 is attached to the outside of the motor housing 120 and positioned on the motor support 122.

In the exemplary embodiment, the extension assembly 6 generally has a boom support 140, a sliding support 150, a sliding mechanism 160 and a raising mechanism 170.

As illustrated in FIG. 6, the boom support 140 is an elongated structural beam. The boom support 140 includes a sliding support receiving passageway 142. The boom support 140 further includes an actuator connector 144 positioned on an outer portion of the boom support 140. The boom support 140 further includes a rear frame connector 146.

The sliding support 150 is an elongated structural beam having an actuator receiving passageway 152 and extending the length of the sliding support 150. The actuator receiving passageway 152 is shaped to receive an actuator and, as shown, a cross section area of the sliding support receiving passageway 142 is larger than a cross section area of the sliding support 150. As a result, a leading end of the sliding support 150 is positioned through the sliding support receiving passageway 142. The sliding support 150 further includes a fastener receiving passageway 154 positioned at a front end thereof and extending completely therethrough.

The sliding mechanism 160 is an actuator which may be a known hydraulic cylinder having a barrel, a piston, piston rod, seals, and seal glands. However, one skilled in the art should appreciate that other actuator systems operated by a source of energy, such as electric current, hydraulic fluid pressure, or pneumatic pressure.

As shown in FIG. 6, the raising mechanism 170 is an actuator which may be a known hydraulic cylinder having a barrel, a piston, piston rod, seals, and seal glands. However, one skilled in the art should appreciate that other actuator systems operated by a source of energy, such as electric current, hydraulic fluid pressure, or pneumatic pressure. One of ordinary skill in the art would understand the main components of a hydraulic cylinder.

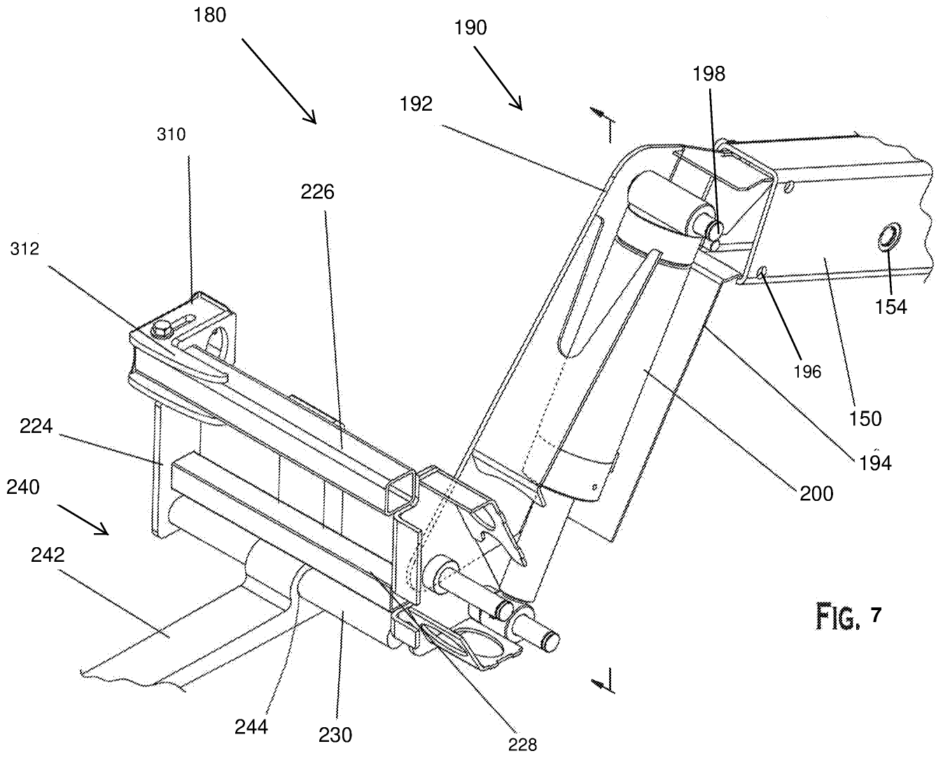

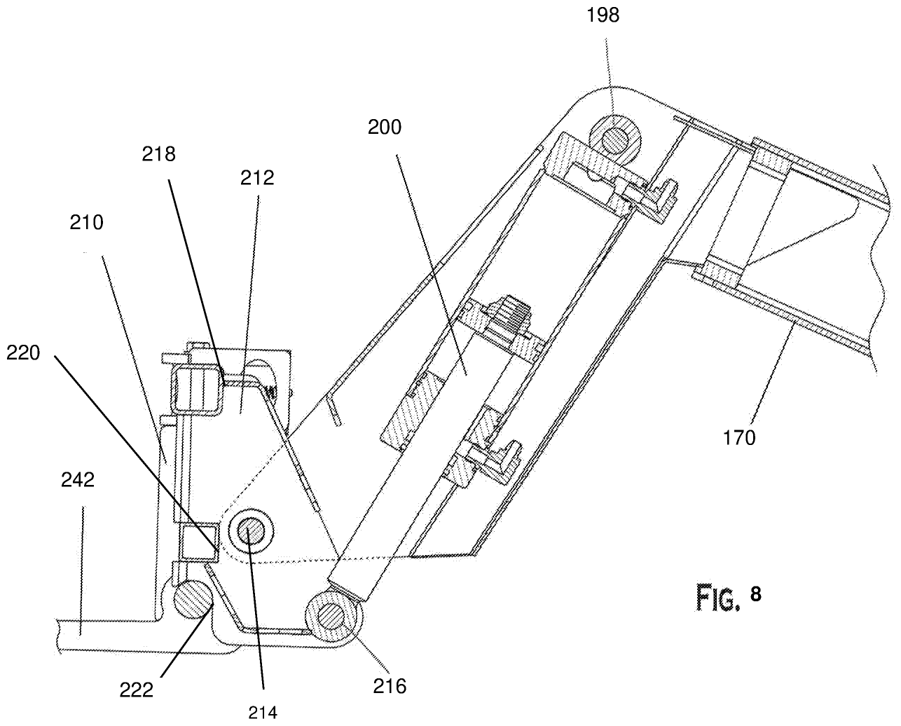

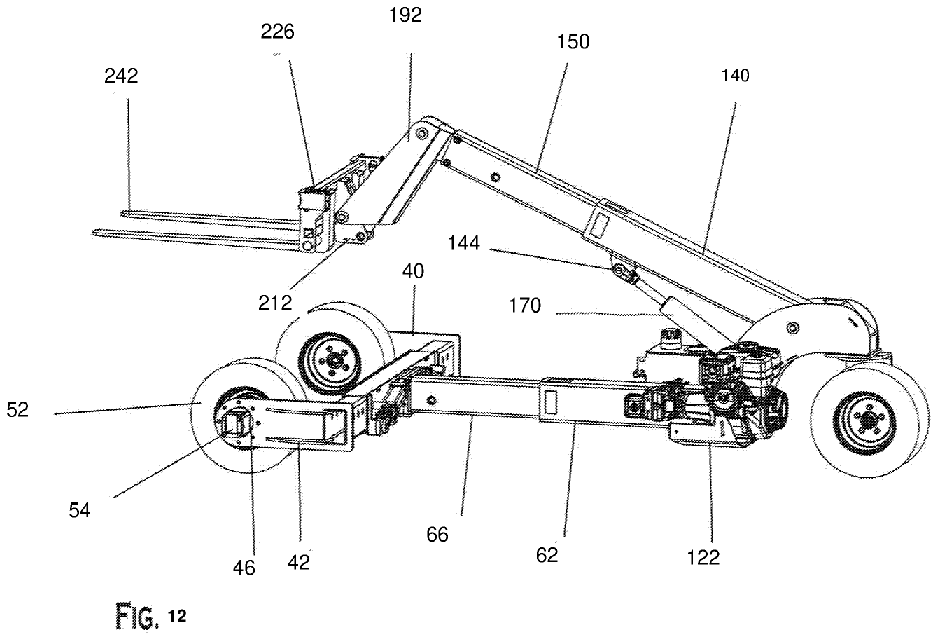

In the exemplary embodiment, the carrier assembly 8 generally has carriage assembly 180. The carriage assembly 180 generally has a knuckle rotation assembly 190, a carriage movement assembly 200, a back rest assembly 210, a prong assembly 240, an alternative embodiment prong assembly 250 and a locking assembly 310 as illustrated in FIGS. 7-11.

The knuckle rotation assembly 190 includes pair of plate like knuckle members 192 and a knuckle bottom plate 194. The knuckle rotation assembly 190 further includes a plurality of fastener receiving passageways 196 positioned at a rear end and extending completely therethrough. The knuckle rotation assembly 190 further includes a first carriage actuator connector 198.

As illustrated in FIGS. 7-8, the carriage movement assembly 200 is an actuator, which may be a known hydraulic cylinder having a barrel, a piston, piston rod, seals, and seal glands. However, one skilled in the art should appreciate that other actuator systems operated by a source of energy, such as electric current, hydraulic fluid pressure, or pneumatic pressure.

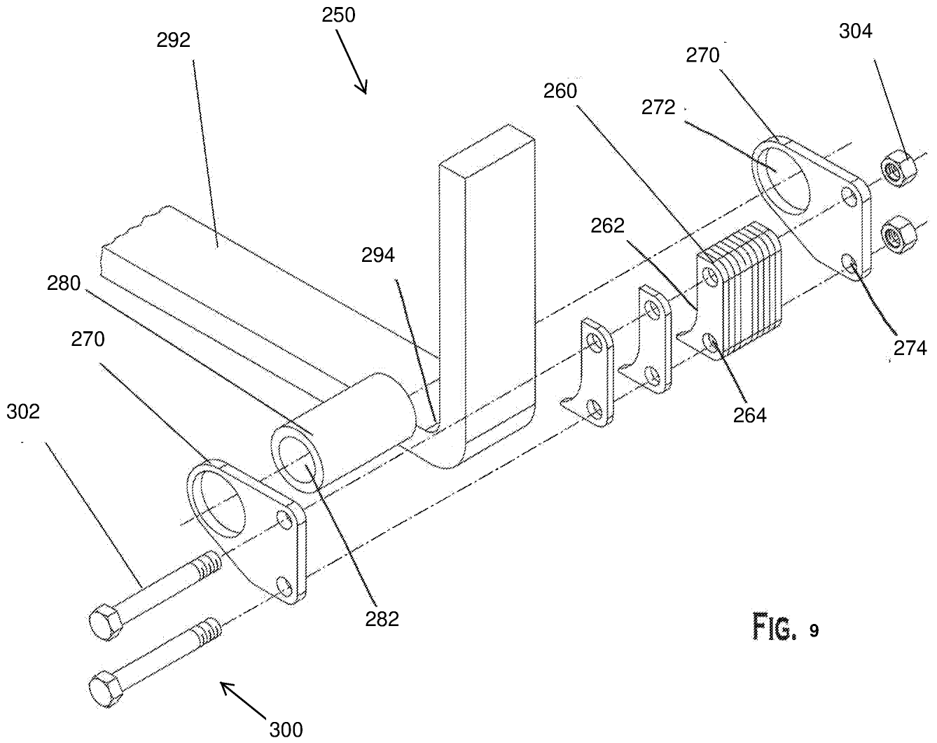

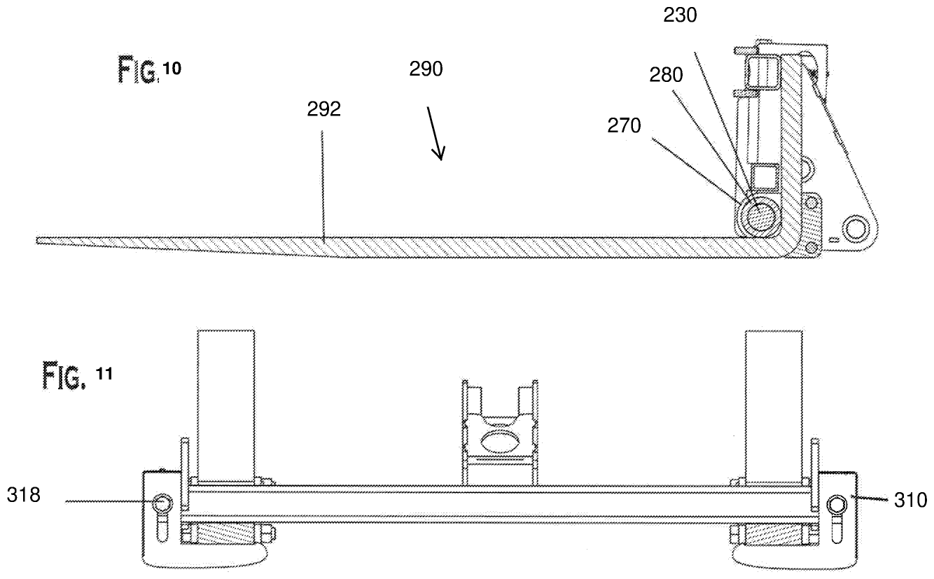

As illustrated in FIGS. 7-8, the back rest assembly 210 includes a mount 212. The mount is a pair of plate like members. The mount 212 further includes a plurality of fastener receivers 214 extending therethrough. The mount 212 further includes a second carriage actuator connector 216 as shown in FIG. 8. The mount 212 further includes a plurality of indented grooves positioned at a front end of the mount 212 as illustrated in FIGS. 9-10. The plurality of indented grooves generally include a top groove 218, a central groove 220 and a bottom groove 222.

The back rest assembly 210 further includes a plurality of bars. The plurality of bars include a pair of outer side bars 224 as illustrated. Each outer side bar 224 is a plate like member. The plurality of bars further include a top bar 226. The top bar 226 is an I beam member. The plurality of bars further include a center bar 228. The center bar 228 is an I beam member.

The back rest assembly 210 further includes a rail 230 positioned below the top bar 226 and the center bar 228. The rail 230 is a rod like member as illustrated.

The prong assembly 240 includes a pair of prolongated plate like members 242 as illustrated. Each of the prolongated plate member 242 includes a rail receiver 244 positioned at an angular portion of the prolongated plate like member 242.

In another embodiment, the prong assembly 250 as illustrated in FIGS. 9-11, includes a plurality of spacers 260, a pair of washers 270, a glide rod 280, a pair of prongs 290 and a fastener system 300.

The plurality of spacers 260 are elongated members. Each spacer 260 includes a prong receiver 262 positioned at a front end thereof. Each spacer 260 further includes a spacer receiving passageway 264.

The plurality of washers 270 are plate like members. Each washer 270 includes a glide rod receiver 272 extending through the washer 270 at one end thereof. Each washer 270 further includes a washer receiving passageway 274.

The glide rod 280 is a cylindrical member. The glide rod 280 further includes a rail receiver passageway 282. One skilled in the art would understand the applicant's design is not the exclusive embodiment.

The pair of prongs 290, are prolongated plate like members 292. One skilled in the art would understand the applicant's design is not the exclusive embodiment. Each of the prolongated plate member 292 includes a positioner 294 positioned at an angular portion of the prolongated plate like member 292.

The fastener system 300 includes a pair of bolts 302 and a pair of fasteners 304. One skilled in the art would understand the applicant's design is not the exclusive embodiment.

In the exemplary embodiment, the locking assembly 310 generally includes a pair of locking claws 312. Each locking claw 312 is an angled plate like member. Each locking claw 312 further includes movement receiver 314.

The locking assembly 310 further includes a spring load member 316 positioned within an interior of the locking assembly 310 and fixed to a front end and a rear end of the locking assembly 310. One skilled in the art would understand the applicant's design is not the exclusive embodiment.

The locking assembly 310 further includes a movement bolt 318 positioned within the movement receiver 314. One skilled in the art would understand the applicant's design is not the exclusive embodiment.

As assembled the front support beam 12 is positioned horizontally as illustrated. The front support actuator assembly 30 is coupled to the rear of the front support beam 12. Each connecting beam 16 is inserted into the receiving space 14 of the front support beam 12. At an opposite end of each connecting beams 16, the opposite end is inserted into the support beam receiver 44. A pair of clasps 42 are positioned on the front wheel assembly 40 and are hook coupled to the connecting beams 16. The front wheel axel connector 54 is positioned through each of the front wheel connectors 46. Each front wheel 52 is attached at an opposite end of each of the front wheel connectors 46.

The frame actuator assembly 70 is positioned within the frame actuator receiving passageway 68 of the extending support 66. The extending support 66 is positioned within the inner frame passageway 64 of the rear frame support 62 as shown. The extending support 66 is coupled to the central region of the front support beam 12 wherein the front support actuator assembly 30 is positioned between the front support beam 12 and the extending support 66 as illustrated. The pair of arched like members 82 of the rear wheel assembly 80 are fastened together and the bottom plate 84 of the rear wheel assembly 80 is coupled to a bottom of the arched like members 82. The rear wheel receiver port 106 of the rear wheel kit 100 is aligned with the rear wheel connector 88 of the bottom plate 84. A bolt B is coupled through the rear wheel connector 88 and the rear wheel receiver port 106. A rear end of the rear frame support 62 is positioned between the pair of arched like members 82 and fastened in place. On a first side of the arched like members 82 the control system 112 is coupled. On a second side, the motor support 122 is coupled and the motor assembly 114 is positioned on the motor support 122.

The sliding mechanism 160 is positioned within the actuator receiving passageway 152 of the sliding support 150. The sliding support 150 is positioned within the sliding support receiving passageway 142. The sliding mechanism 160 is fastened to the sliding support 150 and the boom support 140. At an opposite end from the sliding support 150, the boom support 140 is positioned within the pair of arched like members 82 and coupled by the rear frame connector 146.

The raising mechanism 170 is coupled at one end to the actuator connector 144 of the boom support 140 and coupled at a second end and positioned within the arch like members 82. The raising mechanism 170 is positioned below the boom support 140.

The pair of plate like knuckle members 192 are coupled together. The knuckle bottom plate 194 is coupled to a rear of the plate like knuckle members 192. The plate like members of the mount 212 are fastened together. The top bar 226 is positioned within the top groove 218. The center bar 228 is positioned within the central groove 220. The rail 230 is positioned within the bottom groove 222. The rail 230 is threaded through the rail receiver 244 of the prolongated plate like members 242. The pair of outer side bars 224 are positioned at each end of the top bar 226, center bar 228 and the rail 230. Each locking claw 312 is positioned at each end of the top bar 226 wherein the locking assembly 310 is positioned in front of the top bar 226 and facing inwards.

In another embodiment, the glide rod 280 is positioned along the positioner 294. The plurality of spacers 260 are positioned on each end of each prong 292 by the prong receiver 262. Each washer 270 is positioned on the outside of the plurality of spacers 260, the glide rod 280, and each of the prongs 292. The glide rod 280 is threaded through the glide rod receiver 272. The fastener system 300 is threaded through the washer receiving passageway 274, the spacer receiving passageway 264, and fastened. One skilled in the art would understand the applicant's design is not the exclusive embodiment. The rail 230 is threaded through the prong assembly 250.

The carriage movement assembly 200 is coupled at one end to the first carriage actuator connector 198 and coupled at a second end to the second carriage actuator connector 216.

A rear end of the knuckle rotation assembly 190 is connected to the sliding support 150 by the plurality of fastener receiving passageways 196.

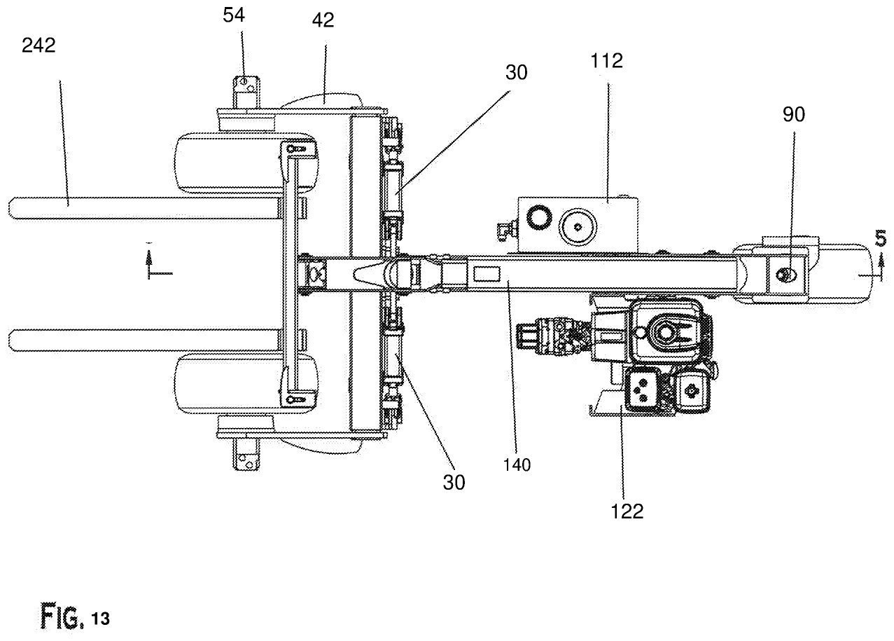

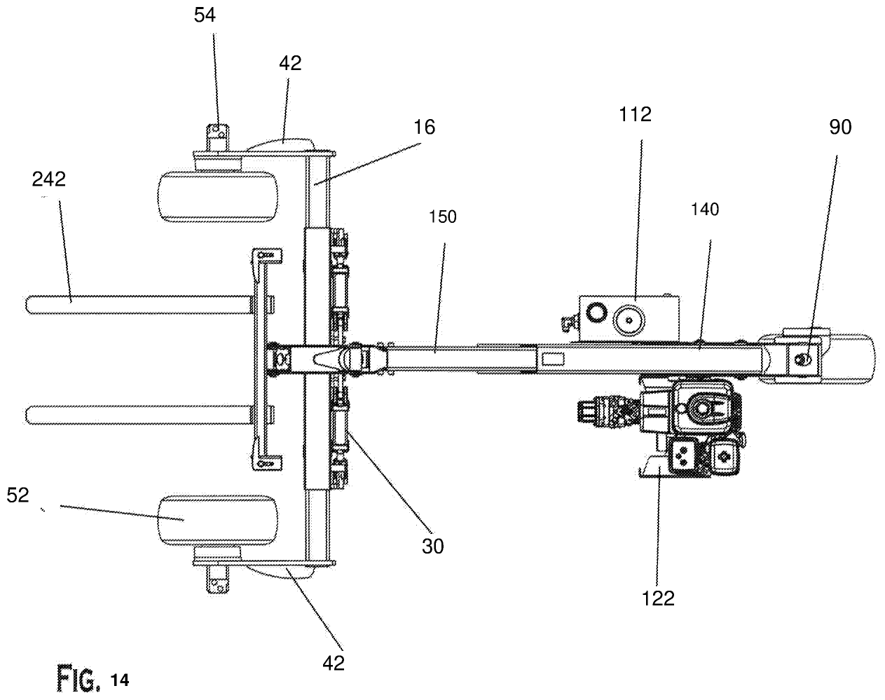

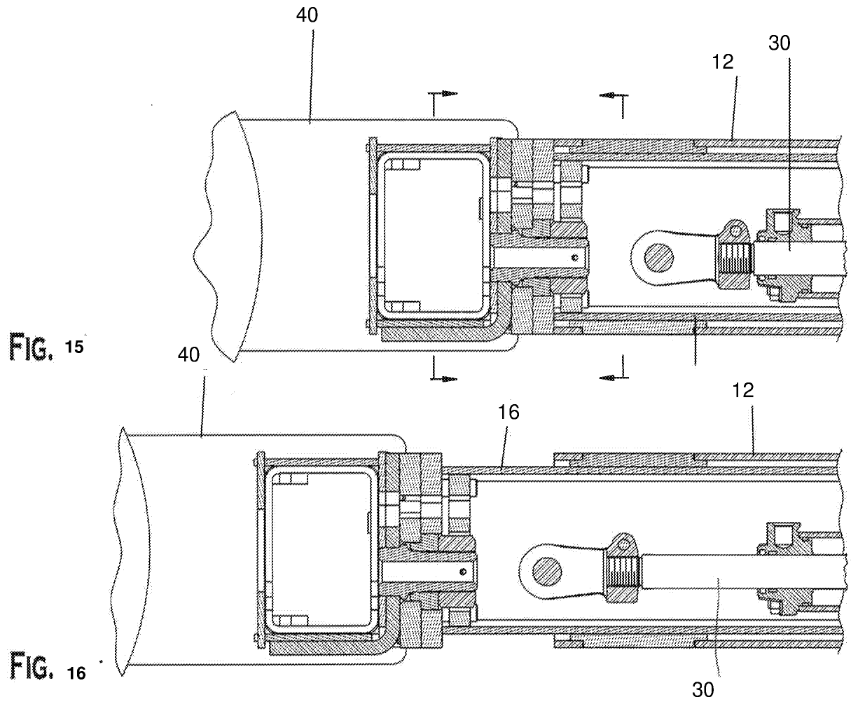

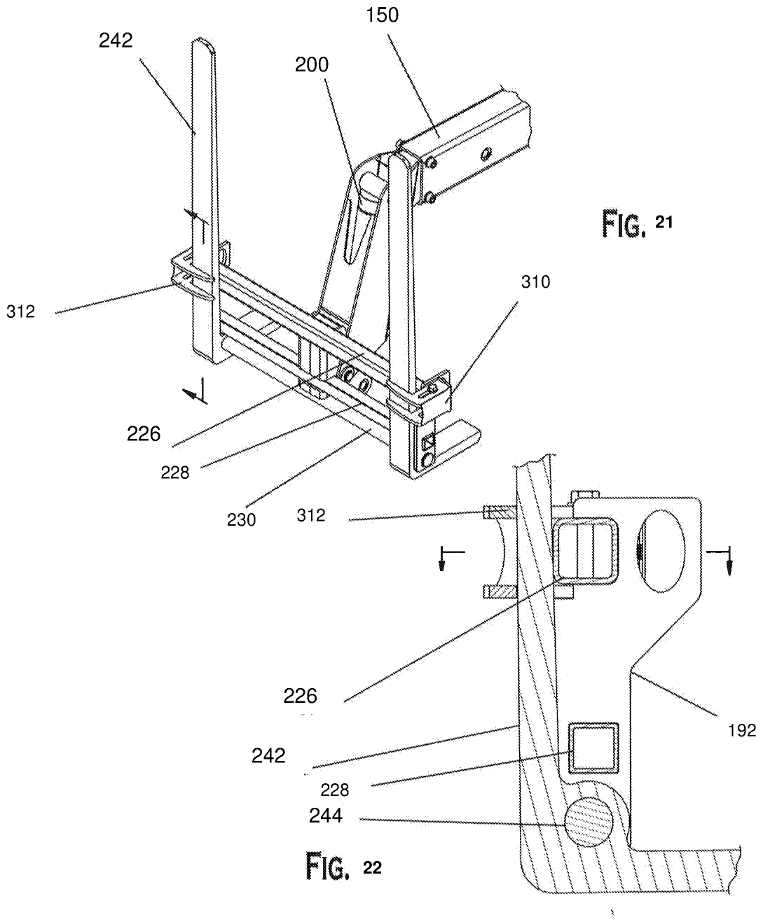

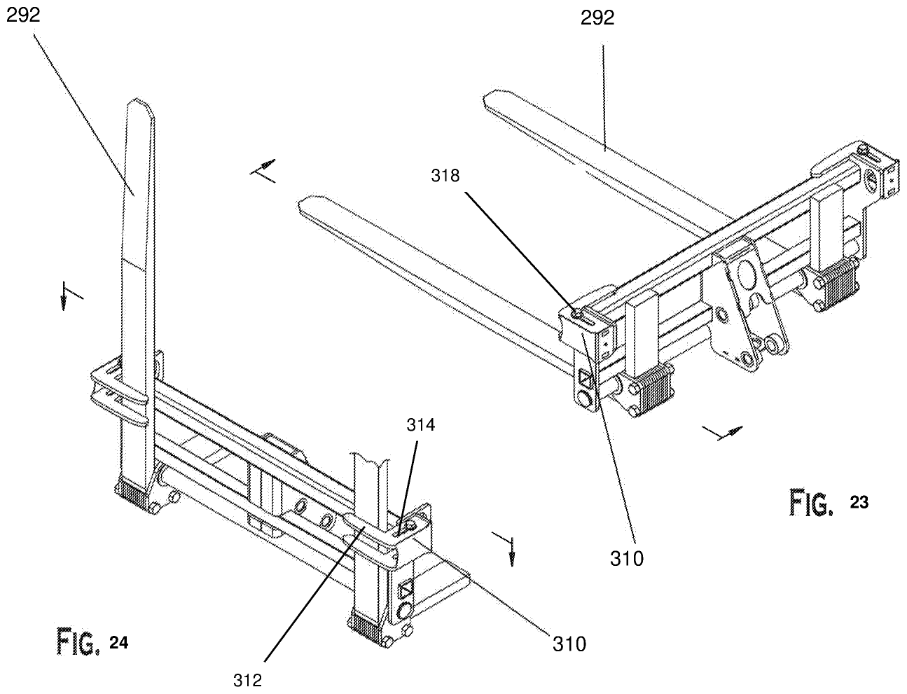

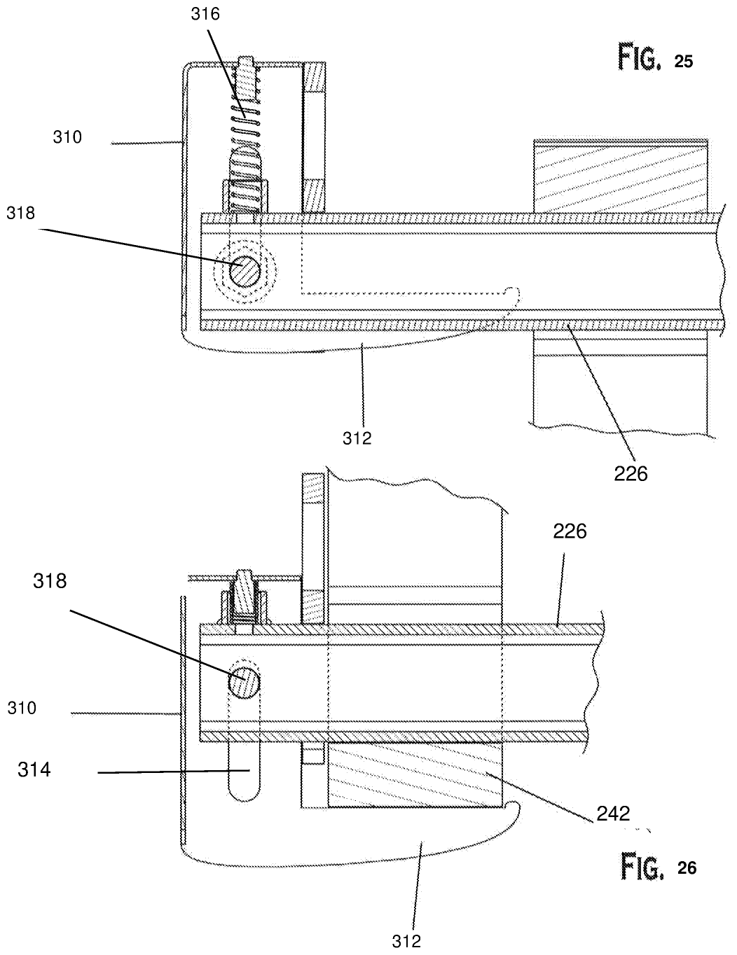

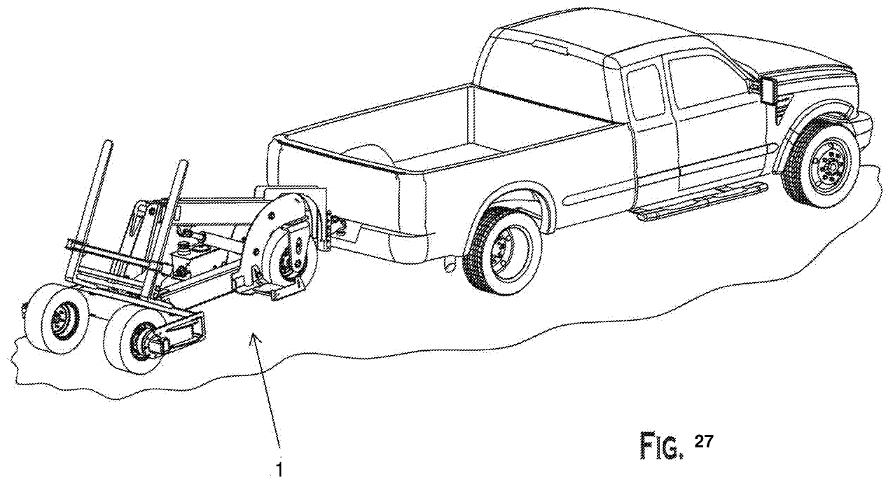

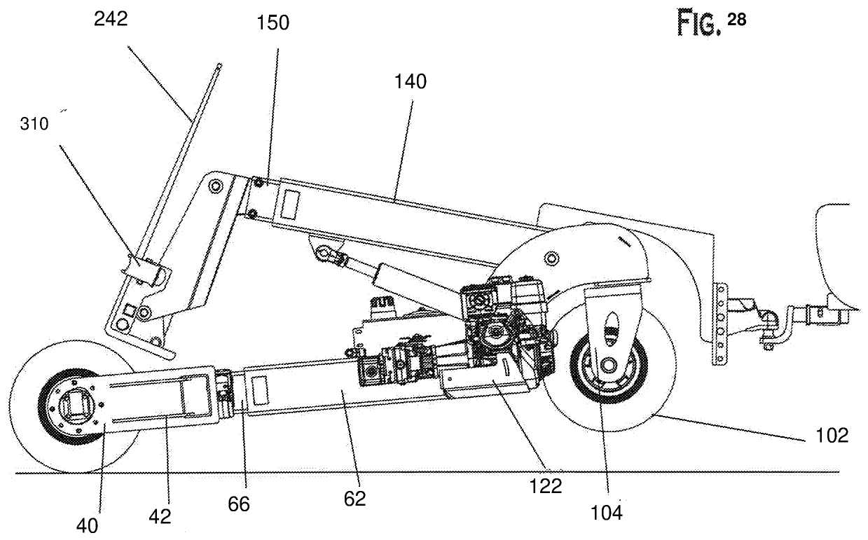

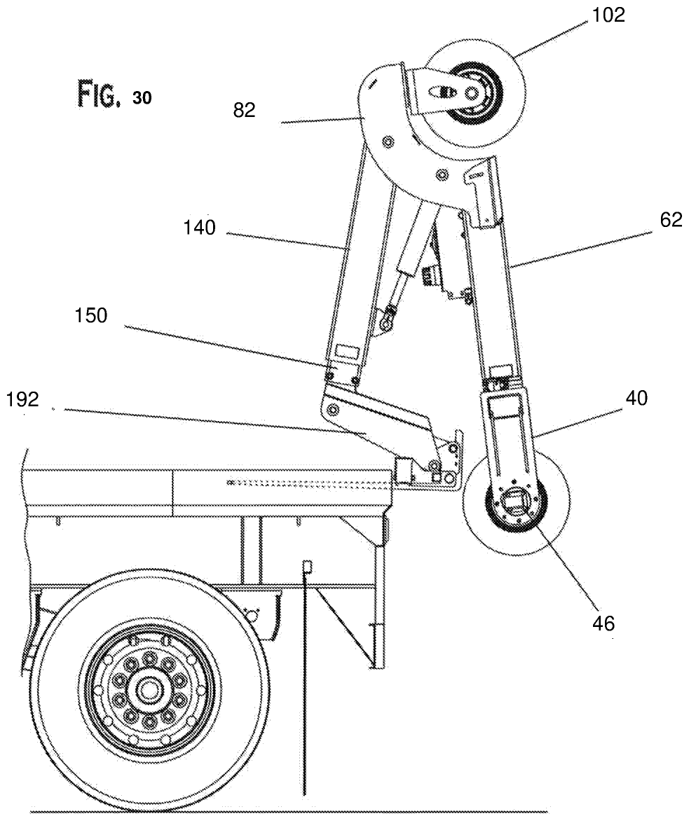

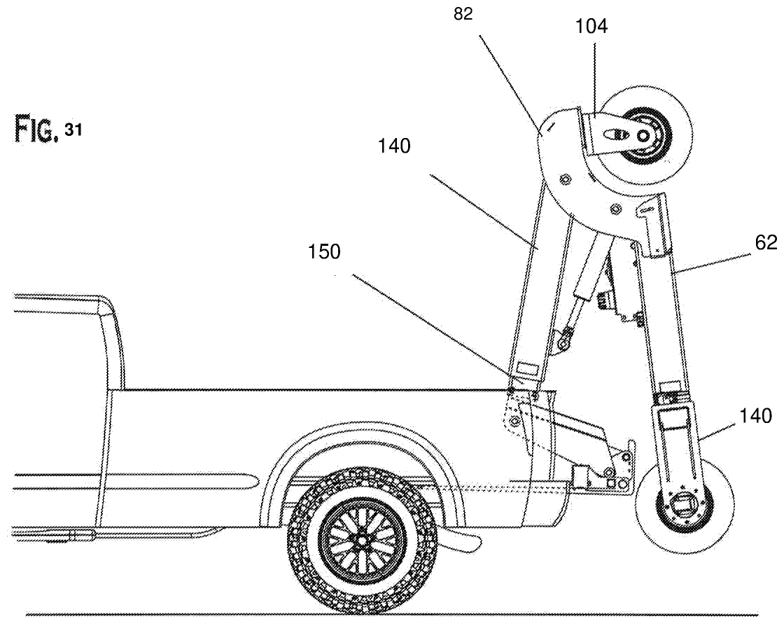

Now with reference to FIGS. 12-31, the operator has the ability to control a plurality of movements for the forklift assembly 1.

As illustrated, the height of the forklift assembly 1 can be stretched and retracted by the raising mechanism 170. The raising mechanism 170 moves the boom support 140 in a first height position and a second height position.

As illustrated, the frame 2 of the forklift assembly 1 can be stretched and retracted by the frame actuator assembly 70. The frame actuator assembly 70 moves the extending support 66 in a first frame 2 length position and a second frame 2 length position.

As illustrated, the frame 2 of the forklift assembly 1 can be stretched and retracted by the front support actuator assembly 30. The front support actuator assembly 30 moves the connecting beams 16 in a first frame 2 width position and a second frame 2 width position. In an alternate embodiment, the connecting beams 16 can be manually moved and positioned by the extension receivers 18 and the plurality of locking pins 20 of the connecting beam 16.

As illustrated, the length of the extension assembly 6 can be stretched and retracted by the sliding mechanism 160. The sliding mechanism 160 moves the sliding support 150 in a first extension position and a second extension position.

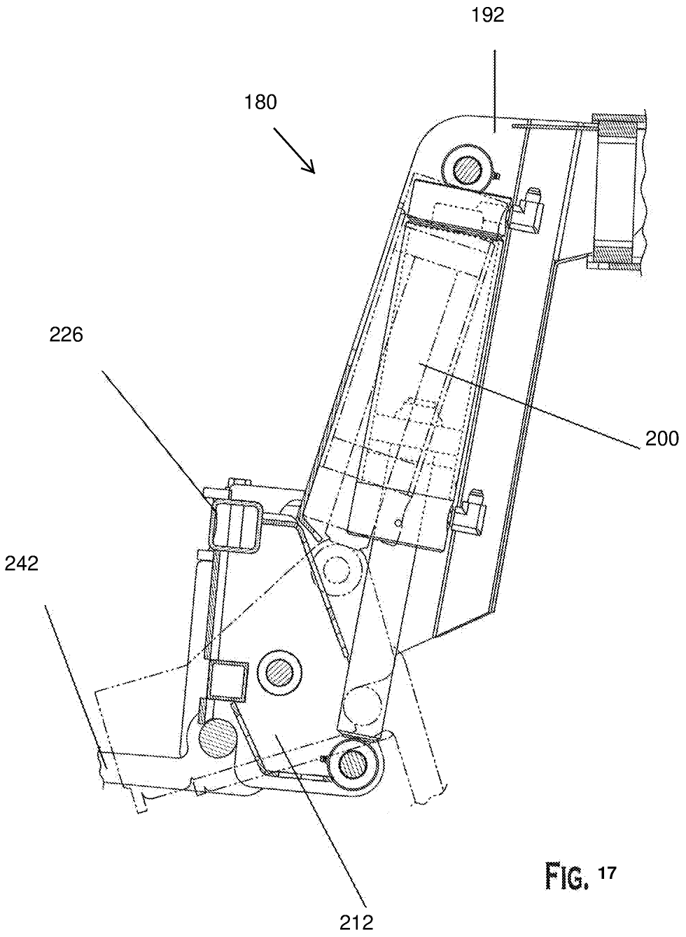

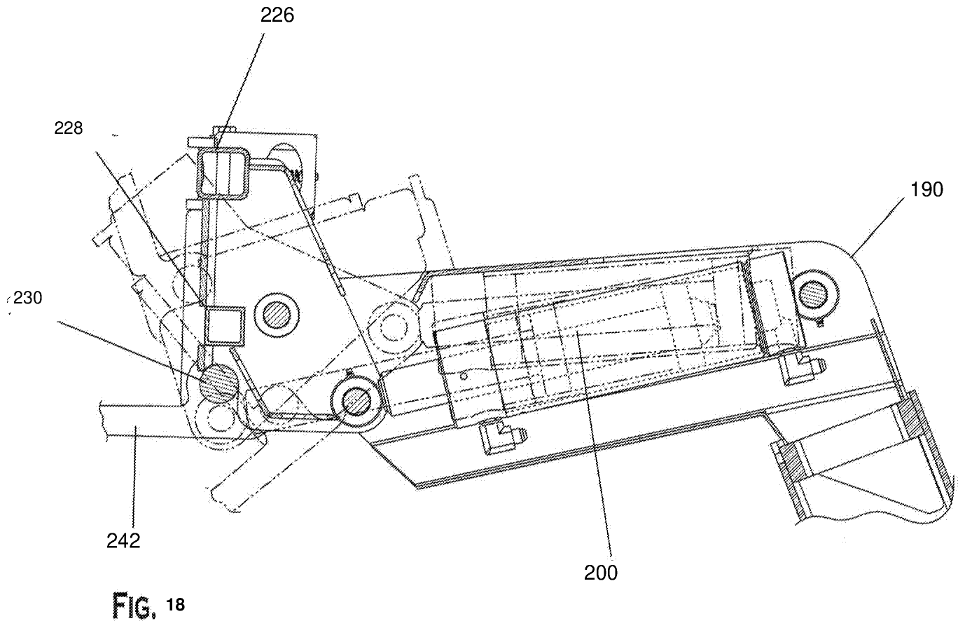

As illustrated in FIGS. 17-18, the knuckle rotation assembly 190 can be rotated in a clockwise direction and a counterclockwise direction by the carriage movement assembly 200 moving the mount 212 of the back rest assembly 210 in a first rotation direction and a second rotation direction.

As illustrated in FIGS. 18-26, the prong assembly 240 can rotate around the rail 230 by the rail receiver 244 of the prolongated plate members 242. In a first position, the prolongated plate members 242 are extended horizontally and a rear of the prolongated plate members 242 are pressed against the rear of the plurality of bars. In a second position, the prolongated plate members 242 are extended vertically and a front of the prolongated plate members 242 are positioned between the locking claws 312 and the top bar 226.

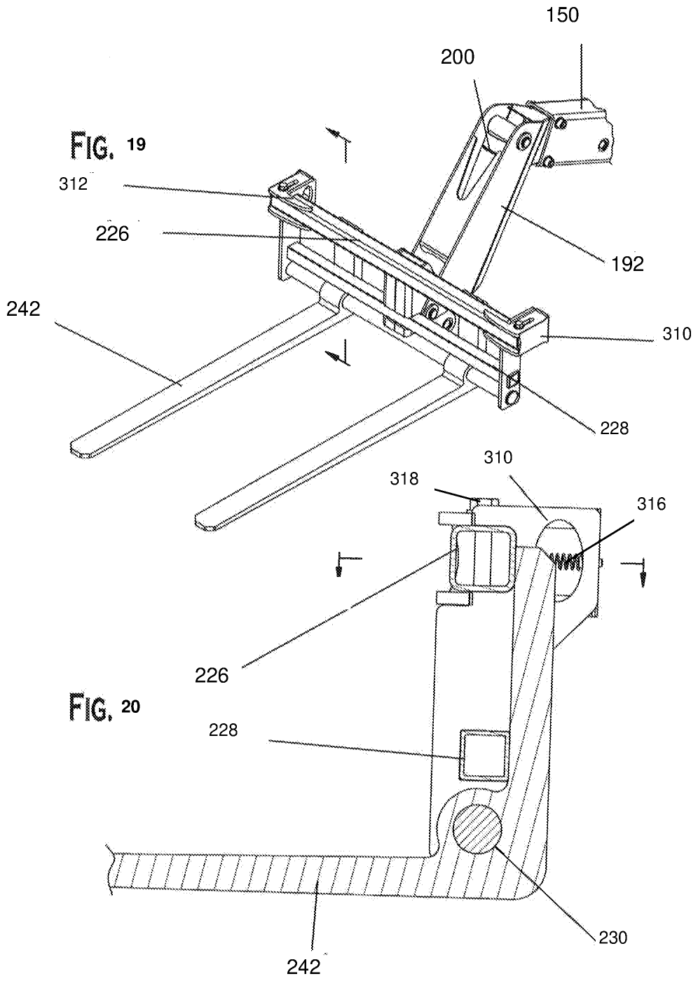

In the exemplary embodiment, the locking assembly 310 is spring loaded as illustrated in FIGS. 19-24. The locking claws 312 extend outwards in which the spring load member 316 expands allowing the members 242, 292 to rotate upwards. Once the members 242, 292 are positioned against the top bar 226, the locking claws 312 retract inwards while the spring load member 316 contracts securing and locking the members 242, 292 in place.

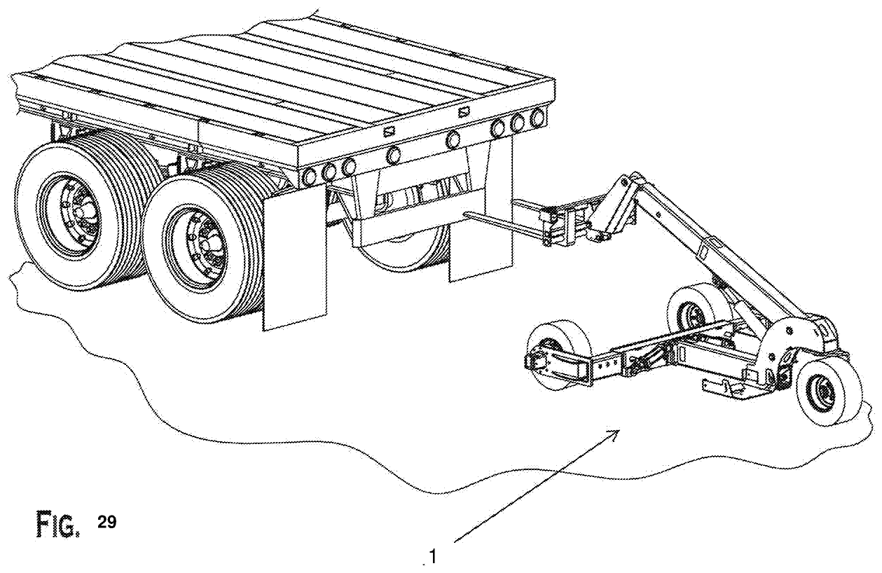

In an alternate embodiment, the locking claws 312 can manually be locked in place by utilizing a locking bolt. As illustrated in FIGS. 27-31, the forklift assembly 1 can be transported in a plurality of positions.

In one embodiment, a hitch can be positioned within the trailer connection slot 90 as shown in FIGS. 27-28. As shown in FIG. 28 an additional fork lock may be positioned between the prolongated plate members 242,292.

In another embodiment, the prolongated plate members 242, 292 are positioned within slots of a trailer as shown in FIG. 29-31. The operator positions the forklift assembly 1 to engage the slots of the truck. When the slots are engaged by the prolongated plate members 242,292, the knuckle rotation assembly 190 rotates in a first position and lifts the frame 2 and the extension assembly 6 above the ground. The front wheel assembly 40 is parallel to the carriage assembly 180.

In another embodiment and similar to the previous embodiment, the forklift assembly 1 is positioned on a bed of a truck. The operator positions the forklift assembly 1 to engage the slots of the truck. When the slots are engaged by the prolongated plate members 242,292, the knuckle rotation assembly 190 rotates in a first position and lifts the frame 2 and the extension assembly 6 above the ground. The front wheel assembly 40 is parallel to the carriage assembly 180.

Additionally, when the forklift assembly 1 is in operation, the control system 112 initiates movement of the forklift assembly 1. While moving, the plurality of sensors S distributed throughout the forklift assembly 1 become active. The sensors S identify a level of the frame 2 and a slope of the extension assembly 6.

When dealing with an uneven ground or surface, the sensors S will relay information to the front support actuator assembly 30 to manipulate and twist in both a dynamical and a mechanical manner to balance the front support assembly 10 to compensate for the terrain. Additionally, the sensors S will relay information to the frame actuator assembly 70 to manipulate and extend or retract a length of the rear support assembly 60 in both a dynamical and mechanical manner in order to compensate for the terrain. While previous forklift assemblies use a counterweight to redistribute the weight when on an uneven surface, the plurality of sensors S permit reconfiguration of the forklift assembly 1 in order to redistribute a center of gravity and transfer weight distribution.

A width of the front support assembly 10 is manually adjustable by gliding the connecting beams 16 along the receiving space 14. When the operator has chosen the correct width, the operator inserts the locking pin 20 into the extension receiver 18. In another embodiment, a pair of outriggers (not shown) lift the front support assembly 10 off the ground, and the operator can adjust the width of the front support assembly 10 in the same manner.

It should be noted that various changes and modifications to the embodiments described herein will be apparent to those skilled in the art. Such changes and modifications may be made without departing from the spirit and scope of the present invention and without diminishing its intended advantages. For example, various embodiments of the systems and methods may be provided based on various combinations of the features and functions from the subject matter provided herein.

What is claimed is:

1. A forklift assembly comprising:
a frame having:
a front support assembly having:
a pair of connecting beams;
a front support actuator positioned to a central region of the front support assembly;
a front wheel assembly; and
a rear support assembly coupled to the front support assembly having:
a rear frame support;
an extending support;
a frame actuator assembly positioned within the extending support;
a rear wheel assembly; and
a movement system assembly having:
a control system having a plurality of sensors; and
an extension assembly coupled to the rear support assembly having:
a boom support;
a sliding support positioned within the boom support;
a sliding mechanism positioned within the sliding support;
a raising mechanism coupled to an outer edge of the boom support; and
a carriage assembly having:
a knuckle rotation assembly;
a carriage movement assembly positioned within the knuckle rotation assembly;
a back rest assembly coupled to the knuckle rotation assembly and the carriage movement assembly; and
a prong assembly;
wherein the plurality of sensors identify a level of the frame and a slope of the extension assembly, the front support actuator assembly and frame actuator assembly compensate for a ground surface through the plurality of sensors.

2. The forklift assembly of claim 1, wherein the front support actuator assembly twists in a mechanical manner.

3. The forklift assembly of claim 2, wherein the frame actuator assembly extends and retracts in a mechanical manner.

4. The forklift assembly of claim 3, wherein a width of the front support assembly is adjustable by the connecting beams.

5. The forklift assembly of claim 4, wherein the front support actuator assembly twists in a dynamical manner.

6. The forklift assembly of claim 5, wherein the frame actuator assembly extends and retracts in a dynamical manner.

7. A forklift assembly comprising:
a frame having:
a front support assembly having:
a pair of connecting beams;
a front support actuator positioned to a central region of the front support assembly;
a front wheel assembly; and
a rear support assembly coupled to the front support assembly having:
a rear frame support;
an extending support;
a frame actuator assembly positioned within the extending support;
a rear wheel assembly; and
a movement system assembly; and
an extension assembly coupled to the rear support assembly having:
a boom support;
a sliding support positioned within the boom support;
a sliding mechanism positioned within the sliding support;
a raising mechanism coupled to an outer edge of the boom support; and
a carriage assembly having:
a knuckle rotation assembly;
a carriage movement assembly positioned within the knuckle rotation assembly;
a back rest assembly coupled to the knuckle rotation assembly and the carriage movement assembly; and
a prong assembly.

8. The forklift assembly of claim 7, wherein the movement system assembly has a control system and a motor assembly.

9. The forklift assembly of claim 8, wherein the back rest assembly includes a mount with a plurality of indented grooves.

10. The forklift assembly of claim 9, wherein the back rest assembly further includes a plurality of bars.

11. The forklift assembly of claim 10, wherein the forklift assembly further includes a locking assembly.

12. The forklift assembly of claim 11, wherein the extending support is positioned within an inner frame passageway of the rear frame support.

13. The forklift assembly of claim 12, wherein the sliding mechanism is fastened to the sliding support and the boom support.

14. The forklift assembly of claim 13, wherein the boom support is positioned within the rear support assembly.

15. The forklift assembly of claim 14, wherein the raising mechanism is coupled to the rear support assembly.

16. The forklift assembly of claim 15, wherein a height of the forklift can be stretched and retracted by the raising mechanism moving the boom support in a first height position and a second height position.

17. The forklift assembly of claim 16, wherein the frame of the forklift can be stretched and retracted by the frame actuator assembly moving the extending support in a first frame length position and a second frame length position.

18. The forklift assembly of claim 17, wherein the frame of the forklift can be stretched and retracted by the front support actuator assembly moving the connecting beams in a first frame width position and a second frame width position.

19. The forklift assembly of claim 18, wherein the knuckle rotation assembly can be rotated in a first rotation direction and a second rotation direction by the carriage movement assembly.

20. A forklift assembly comprising:
a frame having:
a front support assembly having:
a pair of connecting beams;
a front support actuator positioned to a central region of the front support assembly;
a front wheel assembly; and
a rear support assembly coupled to the front support assembly having:
a rear frame support;
an extending support;
a frame actuator assembly positioned within the extending support;
a rear wheel assembly; and
a movement system assembly having:
a control system having a plurality of sensors; and
an extension assembly coupled to the rear support assembly having:
a boom support;
a sliding support positioned within the boom support;
a sliding mechanism positioned within the sliding support;
a raising mechanism coupled to an outer edge of the boom support; and
a carriage assembly having:
a knuckle rotation assembly;
a carriage movement assembly positioned within the knuckle rotation assembly;
a back rest assembly coupled to the knuckle rotation assembly and the carriage movement assembly;
a prong assembly;
a locking assembly; and
wherein the carriage movement assembly in a first rotation direction promotes a pivot movement of the frame and the extension assembly, the front wheel assembly is parallel to the carriage assembly.
